(19) United States
(12) Patent Application Publication
(10) Pub. No.: US 2006/0144317 A1
(43) Pub. Date: Jul. 6, 2006

(54) Linemark the last line you read

(76) Inventor: Chi W. Chan, Bayside, NY (US)

Correspondence Address: Chi Chan, 201 - 02 26 avenue, Bayside, NY, 11360, US

(21) Appl. No.: 11/325,219

(22) Filed: Jan. 3, 2006

Related U.S. Application Data
(60) Provisional application No. 60/640,655, filed on Dec. 31, 2004.

(51) Int. Cl. B42D 9/00

(52) U.S. Cl. 116/236

(57) ABSTRACT

A bookmark that easily locate the exact page and line of any size book or paper document. It is made from a one-piece construction with a U-shaped cutout folded inward onto itself to form a clip. The bookmark can clip onto, either the left or right pages of a book without any adjustment. Both sides of the bookmark have flat surfaces, in order to prevent any damage to paper material.

### CROSS REFERENCE TO RELATED APPLICATIONS

This application claims the benefit of provisional application Ser. No. 60/640,655, filed Dec. 31 2001 by the present inventor.

### FEDERALLY SPONSORED RESEARCH

Not Applicable

### SEQUENCED LISTING OR PROGRAM

Not Applicable

### BACKGROUND OF THE INVENTION

1. Field of Invention

This present invention relates to bookmarks of the clip type that are capable of returning a reader to a desired page and a specific line in the page

2. Prior Art

During the course of reading a book, a person would have to stop countless times in the middle of reading the book for various reasons. A bookmark is a helpful tool that locates the desired page where the reader wants to return to reading. The problem with bookmarks is the reader will still have to figure out which two pages he or she last left off and which line they want to return to. Furthermore, these bookmarks can easily fall out from between the pages. Sometimes a reader spends so much more time and aggravation trying to figure out where they last left off, that they might as well have reread both pages and save themselves the additional time and aggravation by trying to remember what line they have read. There have been a great deal of bookmark inventions over the years that try to approach the problems of saving the reader time by identifying the exact page, paragraph, and line read, but these inventions failed to save readers time and end up causing more wasted time. Because it was too cumbersome and took too long to apply, and still only gave a general marking to where you last left off. In addition, some of these bookmarks, end up damaging the pages of book when used.

U.S. Pat. No. 4,901,665 to Carlin (1990) A bookmark that tries to locate an exact line, and page in a book, by using a bookmark with a sliding index around the body of the bookmark, that moves vertically to align with the text. The problems with this invention: First, the size of the bookmark will only work with a limited amount of books that are close to the size of the bookmark. Second the bookmark has a tendency to slide in different directions inside the book or fall downwardly out of the book when the book is picked up to be shelved or carried to a different place to be read. Even when the reader undergoes the inconvenience of carefully shelving and reopening the book in a horizontal orientation, this bookmark would moved upon reopening the book, causing the reader to spend more time trying to figure out where he or she left off and thereby defeating the purpose of the invention in saving time for the reader. The same problems occur in designs U.S. Pat. No. 1,232,116 to Stechan (1917), and U.S. Pat. No. 5,081,948 to Walsh (1992).

There are a few bookmarks that try to make provisions of the fact that the bookmarks would often time slide in different directions inside the book or fall out of the book U.S. Pat. No. 5,577,459 to Alden (1996), U.S. Pat. No. 6,948,447 to Yingling (2005), and U.S. Pat. No. 6,796,266 B1 to Castillo (2004) The way these bookmarks work is to have the reader spend much time looking up what page and paragraph was last read, then the reader would have to mark it in the bookmark by using a sliding or rotating mechanism band around the body of the bookmark to indicated where the readers are last page and paragraph read these bookmarks are limited in their capability and unable to mark the line of the text. In addition to the reader having to reread some passages already read, the reader are also spending much of their time trying to find out what paragraph and what: page they are reading, it defeats the purpose of having a bookmark to save time. The main purpose of a bookmark is to save time so you don't have to reread passages or waste time remembering where you last left off. A bookmark should be a convenience to use, easy to carry and not damaging a book through its use.

Several types of clip-like bookmarks have recently come on the market like U.S. Pat. No. D437613 to Melnyk (2001) and U.S. Pat No. D408447 to Base (1999), Although these bookmarks do a better job of pointing out the desired passage in a book to be read later, then the previous mentioned patents, there is still a great disadvantage to these designs. These bookmark designs would require the use of both hands to complete the markings of the readers last spot in the book. Once applied, it is not always easy to remove or reapply to the paper and paper will sometimes become damaged through its use. This is especially the case with U.S. Pat. No. D408447 which will leave an indentation on the pages of the book. And because of its small size, it sometime does not reaches the text that it is suppose to mark.

These and all other prior art bookmarks are often
a) Are cumbersome to use and bulky in size.
b) Take too long to implement bookmark and still not able to give an accurate marking where the reader last left off.
c) Only able give general marking to last paragraphs read.
d) Causing the reader to reread passages already read.
e) Prone to falling out or out of place in a book.
f) Often times, they require the use of both hands to complete the marking of the reader's place in the book.
g) Some bookmarks only work on limited size of books.
h) Some bookmarks will leave creases, tears, indentations and other damages to the pages of a book through its use.

### OBJECTS AND ADVANTAGES

Accordingly, objects and advantages of the invention are to provide an improved bookmark, the following are:
a) A bookmark that is small and easy to handle in size.
b) A bookmark that is fast and easy to use.
c) A bookmark that gave an accurate marking to the last line read.
d) Save reader time, so they don't have to reread passages already read.
e) A bookmark that can be securely attached to any size book or paper document.
f) A bookmark that easily marks the page of a book or a paper document with the use of just one hand.
g) A bookmark that can be used on any-sized book or paper document.
h) A bookmark that can be easily and repeatedly repositioned to a book or paper documents without damage.
i) A bookmark that is ergonomically designed for easy handling.
j) A bookmark that used a straight edge to underline the text where the reader wants to remember.
k) A bookmark that has a circular tab that help reader find and reopen the book to where the lone is mark.
l) A bookmark that is inexpensive to manufacture
m) A bookmark that will not leave any creases, tears, indentations, or any other damages when used.

Further objects and advantages will become apparent from study of the following description and the accompanying drawings.

### SUMMARY OF THE INVENTION

In accordance with one embodiment of the bookmark of the present invention, A bookmark that can easily mark and located an exact line in a book or paper document that reader want to remember, by using just one hand and will not damage the paper.

### BRIEF DESCRIPTION OF TEE DRAWING FIGURES

FIG. 1 A top perspective view of the bookmark in use on a book with two sides of the open book.

FIG. 2: A top perspective view of the bookmark in use on a closed book with the circular tab acting as a folder tab and visual aid that brings attention to readers when the book is closed.

A top perspective view of the bookmark

FIG. 3: A top perspective view of the bookmark in use on a paper document.

FIG. 4: A top perspective view of the back of the bookmark in use on a paper document.

FIG. 5: A perspective view of the front bookmark.

FIG. 6: A perspective view of the back bookmark.

FIG. 7: A schematic drawing of the production process.

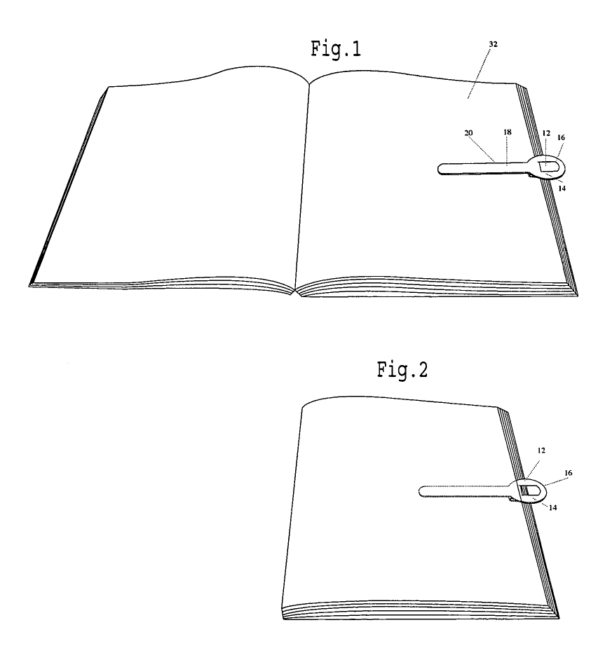

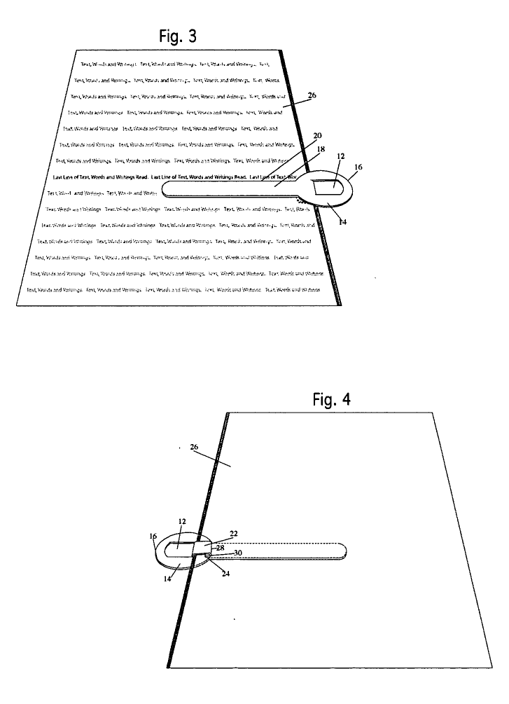

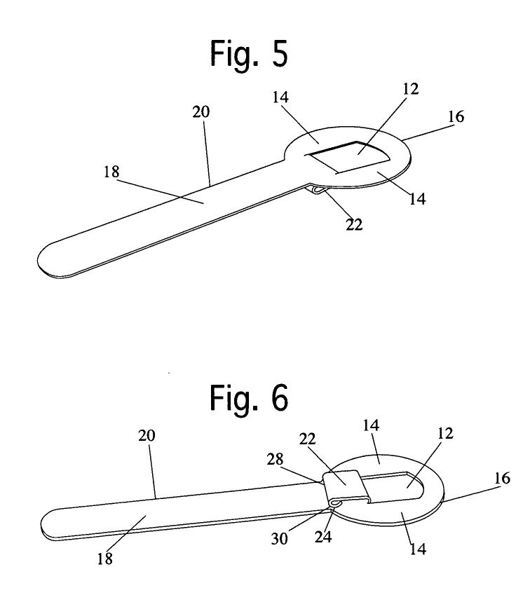

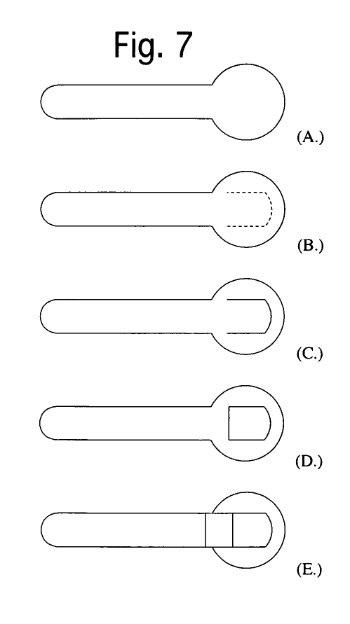

### DRAWING REFERENCE NUMERALS

12—Ergonomic handle

14—Additional holding area

16—A circular disk that acts as a tab

18—Flat surface of the front

20—A straight edge that brings attention to a line the reader wants to remember

22—The flat surface of the back

24—Clip that holds the pages together

26—Papers

28—Curve on the end of the clip

30—The space between curve and the back of the clip

32—Book

I claim:

1. A bookmark that will accurately identify a line on page of a book or paper document for a reader comprising:
a) A bookmark with a straight edge with a clip at the end of the bookmark.
b) The bookmark can be use on either the right or left side pages of the book without making any adjustments to the bookmark.
c) The straight edge of the bookmark brings clear and precise visual attention to a line the reader needs to refer back to.
d) Can be used for any size book or document regardless of thickness or dimension

2. Safe to use bookmark will not damage the paper of your book or document.
a) The u shaped cutout at one end is folded inwards onto itself forming a clip with curve at both ends, the space in between allows it to tightly and gently grip the page without damage.
b) Will not leave any crimps, creases, tears, indentations or any other damage on the page.
c) Can be repositioned repeatedly as necessary without damage.

2. Only one hand is needed when using this bookmark.
a) The space between the clips curve and the bookmark provides an easy gliding mechanism that makes it unnecessary for the use of a second hand to hold the page when inserting the bookmark.
b) Ergonomically designed bookmark for ease of use.
a) Small easy to handle with one hand.

3. Circular tab on the bookmark provides a visual aid when closed to be easily located for usage later.

4. This bookmark may be used in place of a paperclip without the damage. It leaves no creases like paperclips tend to do.
